(19) United States
(12) Patent Application Publication
(10) Pub. No.: US 2023/0191388 A1
(43) Pub. Date: Jun. 22, 2023

(54) HYDROPROCESSING METHOD INCLUDING NONADSORPTIVE CATALYST PARTICLES

(71) Applicant: Saudi Arabian Oil Company, Dhahran (SA)

(72) Inventor: Omer Refa KOSEOGLU, Dhahran (SA)

(21) Appl. No.: 18/159,863

(22) Filed: Jan. 26, 2023

Related U.S. Application Data
(62) Division of application No. 17/140,827, filed on Jan. 4, 2021.

(51) Int. Cl. B01J 37/02; B01J 37/00; B01J 37/04; B01J 37/08; B01J 37/20

(52) U.S. Cl. CPC B01J 37/0221; B01J 37/0072; B01J 37/04; B01J 37/08; B01J 37/20

(57) ABSTRACT

Nonabsorptive presulfided catalyst particles are provided which are coated with a suitable coating material such as paraffinic oil/wax, or a suitable polymer material, to prevent water adsorption on the catalyst particles.

### RELATED APPLICATIONS

Not applicable.

### BACKGROUND OF THE INVENTION

### Field of the Invention

The present invention relates to catalysts and methods for manufacturing catalysts for hydroprocessing of petroleum and petroleum fractions.

### Description of Related Art

Hydroprocessing (hydrotreating and hydrocracking) catalysts can be manufactured by a variety of methods. The method chosen usually represents a balance between manufacturing cost and the degree to which the desired chemical and physical properties are achieved. Although there is a relationship between catalyst formulation, preparation procedure, and catalyst properties, the details of that relationship are not always well understood due to the complex nature of the catalyst systems. The chemical composition of the catalyst plays a critical role in its performance; the physical and mechanical properties also play a major role. The preparation of hydrocracking catalysts involves several steps: precipitation, filtration (decantation, centrifugation), washing, drying, forming, calcination, and impregnation. Other steps, such as kneading or mulling, grinding, and sieving, may also be required. Depending on the preparation method used, some of these steps may be eliminated, whereas other steps may be added. For example, kneading or co-mulling of the wet solid precursors is used in some processes instead of impregnation. When the metal precursors are co-precipitated or co-mulled together with the support precursors, the impregnation step can be eliminated. Described below are the steps that are an integral part of hydrocracking catalyst manufacturing processes.

Hydroprocessing catalysts are hygroscopic and adsorb water upon exposure to air. Water adsorption results several disadvantages, for example, weight gain, activity loss, etc., for the catalyst. After loading in the reactor, the hydroprocessing catalysts are sulfided to convert active phase metals to sulfide form from oxide form. The hydroprocessing catalysts are also offered in presulfided form by the catalyst manufacturers and the catalysts are often activated with hydrogen. However, it is reported that if the sulfide catalysts are exposed to air, the activity of the catalyst decreases (F. E. Massoth, C.-S. Kim, Jian-W. Cui, “Studies of molybdena-alumina catalysts: XVII. Sulfided catalysts exposed to air”, Applied Catalysis, Volume 58, Issue 1, 5 Feb. 1990, Pages 199-208.)

FIG. 1 shows typical catalyst manufacturing steps, for example for manufacturing hydroprocessing catalysts. Hydroprocessing catalysts refer to those used for hydrodesulfurization, hydrodenitrogenation, hydrocracking, hydrodewaxing, hydrogenation, and/or hydrodemetalization. In certain operations hydroproces sing catalysts are composed of one or more active components impregnated on a support material. The support material components are provided at steps 102, 104. At step 102 a binder material is provided, and at step 104, an active catalyst support material such as zeolite is provided. The support material components are mixed and kneaded, step 106. Precipitation involves the mixing of solutions or suspension of materials, resulting in the formation of a precipitate, which may be crystalline or amorphous. Mulling or kneading of wet solid materials usually leads to the formation of dough that is subsequently formed and dried. The mulled or kneaded product is subjected to thermal treatment in order to obtain a more intimate contact between components and better homogeneity by thermal diffusion and solid-state reactions. Precipitation or mulling is often used to prepare the support for the catalyst, and the metal component is subsequently added by impregnation for example, using incipient wetting methods.

The support characteristics determine the mechanical properties of the catalyst, such as attrition resistance, hardness, and crushing strength. High surface area and proper pore-size distribution are generally required. The pore-size distribution and other physical properties of a catalyst support prepared by precipitation are also affected by the precipitation and the aging conditions of the precipitate as well as by subsequent drying, forming, and calcining.

The final shape and size of catalyst particles are determined in the manufacturing step. Examples of the shapes of the catalysts and catalyst supports are shown in FIG. 2. Catalysts and catalyst supports are formed into several possible shapes such as spheres 202, cylindrical extrudates 204, or shaped forms such as a trilobe 206 or a quadrilobe 208. Spherical catalyst support catalyst can be obtained by “oil dropping,” whereby precipitation occurs upon the pouring of a liquid into a second immiscible liquid. Other spherical processes include marmurizing. Generally, because of cost and process considerations such as pressure drop, the majority of catalysts are currently formed in shapes other than spheres. Fewer spherical catalysts are used in modern hydrocracking.

At step 108, non-spherical shapes are obtained by mixing raw materials to form an extrudable dough which is extruded through a die with perforations. The spaghetti extrudate is dried, calcined, and broken into short pieces. The typical length to diameter ratio of the catalyst base varies, for instance, between 2 and 4. The simplest form is a cylindrical particle, but other forms such as trilobes, twisted trilobes, or quadrilobes are also commercially used. Catalysts with multilobed cross sections have a higher surface-to-volume ratio than simple cylindrical extrudates. When used in a fixed bed, these shaped catalyst particles help reduce diffusion resistance, create a more open bed, and reduce pressure drop.

At step 110, the support particles are thermally treated and calcined. Thermal treatment is applied either before and/or after impregnation of the formed catalyst. For catalysts prepared by precipitation or co-mulling of all the components (including the metal components), only drying may be required prior to forming, with subsequent calcination of the formed product. Thermal treatment of the catalyst or support eliminates water and other volatile matter; calcining also serves to decompose impregnated metal salts, including decomposition of nitrates, chlorides, carbonates and organic chelates, leaving a metal or metal oxide on the support surface. The drying and calcination conditions are of critical importance in determining the physical as well as catalytic properties of the product. Surface area, pore-size distribution, stability, attrition resistance, crush strength, and the catalytic activity are affected by the drying and calcination conditions.

At step 112, active metals are added to the calcined support material, generally referred to as impregnation. Several methods may be used to add the active metals to the base: (a) immersion (dipping), (b) incipient wetness, and (c) evaporative. In the most commonly used method, a calcined support is immersed in an excess of solution containing active metals or metal compounds. The solution fills the pores and is also adsorbed on the support surface, and excess solution is removed. In another method, impregnation is carried out using incipient wetness by tumbling or spraying the activated support with a volume of solution having a concentration of metal compound tailored to achieve the targeted metal level, equal to or slightly less than the pore volume of the support. The metal-loaded support is then dried and calcined, step 114. Metal oxides are formed in the process; the calcination step is also referred to as oxidation. In another method, evaporative impregnation, the support is saturated with water or with acid solution and immersed into the aqueous solution containing the metal compound. That compound subsequently diffuses into the pores of the support through the aqueous phase.

The final catalyst product after calcination, at step 116, are bagged and shipped-out to the final destinations. Some catalysts, particularly those containing zeolites, are hygroscopic and therefore adsorb water after the calcination, for instance during transit and prior to use at the final destinations. In addition, as noted above activities of sulfide or oxide catalysts after exposure to air are known to be decreased.

Despite the many advances in hydroprocessing catalysts, the industry is constantly seeking improved catalyst materials, particularly those with improved storability.

### SUMMARY

The disclosure relates to a catalyst manufacturing method in which the catalyst particles are rendered nonabsorptive by treatment with a coating material such as paraffinic wax that is decomposed at catalyst activating conditions in operation in a hydroprocessing reactor.

The steps described above are conventional steps. The catalyst after calcination are bagged and shipped-out to the final destination. Some catalysts particularly those containing zeolite are hygroscopic and adsorb water after the calcination to the final arrival at a site. As noted herein it is known that if the sulfide or oxide catalysts are exposed to air, decreased catalytic activity occurs. This problem is overcome by the nonabsorptive catalyst particles disclosed herein and methods for manufacturing nonabsorptive catalyst particles. These nonabsorptive catalyst particles prevent water adsorption on the catalyst particles and retain the catalytic activity.

In one embodiment, a process for manufacturing catalysts for use in a catalytic process is provided. Active catalyst support material and binder material are mixed to form a catalyst support blend. The catalyst support blend is extruded and formed in an extruder to produce catalyst support particles having an average cross-sectional dimension of between about 0.01-3.0 mm. The catalyst support particles are calcined to produce calcined catalyst support particles. One or more active components are incorporated in the calcined catalyst support particles to produce catalyst particles having active components. The catalyst particles having active components are calcined to remove volatile and contaminant materials to produce hygroscopic catalyst particles. The hygroscopic catalyst particles are coated with a coating material to produce nonabsorptive catalyst particles.

In one embodiment, a process for manufacturing catalysts for use in a catalytic process is provided. Active catalyst support material and binder material are mixed to form a catalyst support blend. The catalyst support blend is extruded and formed in an extruder to produce catalyst support particles having an average cross-sectional dimension of between about 0.01-3.0 mm. The catalyst support particles are calcined to produce calcined catalyst support particles. One or more active components are incorporated in the calcined catalyst support particles to produce catalyst particles having active components. The catalyst particles having active components are calcined to remove volatile and contaminant materials to produce hygroscopic catalyst particles. The hygroscopic catalyst particles are presulfided to produce presulfided hygroscopic catalyst particles. The presulfided hygroscopic catalyst particles are coated with a coating material to produce nonabsorptive presulfided catalyst particles.

In certain embodiments, the active catalyst support material comprises zeolite. In certain embodiments, the binder material comprises metal oxide.

In certain embodiments, the coating material is paraffinic wax with carbon number in the range 31-50. In certain embodiments, the coating material is an n-paraffin wax. In certain embodiments, coating material is dissolved in a paraffinic or aromatic solvent with a carbon number in the range of 5-7, such as pentane, hexane, benzene, toluene, or naphtha boiling in the range of 36-100° C. In certain embodiments, the coating material is a polymer or mixtures of polymers that are derived from olefins, carbonates, aromatics, sulfones, fluorinated hydrocarbons, chlorinated hydrocarbons, or acrylnitrodes.

In certain embodiments, the coating material is spayed over the hygroscopic catalyst particles in a batch or continuous manner. In certain embodiments, the coating material is poured over the hygroscopic catalyst particles. In certain embodiments, the hygroscopic catalyst particles are immersed in coating material and drained.

In certain embodiments, coating occurs at a temperature that is greater than the melting point of the coating material and less than the boiling point of the coating material. In certain embodiments, coating occurs at a pressure range of about 1-3 bars. In certain embodiments, the catalyst is cooled to room temperature before it is coated.

A hydroprocessing method is provided comprising using the nonadsorptive catalyst particles formed according to any of the above processes, wherein nonadsorptive catalyst particles are loaded into a reactor, and the reactor is heated during startup to a suitable temperature to remove coating material from the catalyst particles. In certain embodiments, the catalyst particles are sulfided after coating material is removed.

A nonabsorptive catalyst material is provided comprising active catalyst support material and binder material formed as extrudates and incorporating active components, the extrudates encapsulated with a coating material comprising n-paraffinic wax with carbon number in the range 31-50 or a polymer having a melting point in the range of 83-327° C.

Still other aspects, embodiments, and advantages of these exemplary aspects and embodiments, are discussed in detail below. Moreover, it is to be understood that both the foregoing information and the following detailed description are merely illustrative examples of various aspects and embodiments, and are intended to provide an overview or framework for understanding the nature and character of the claimed aspects and embodiments. The accompanying drawings are included to provide illustration and a further understanding of the various aspects and embodiments, and are incorporated in and constitute a part of this specification. The drawings, together with the remainder of the specification, serve to explain principles and operations of the described and claimed aspects and embodiments.

### BRIEF DESCRIPTION OF THE DRAWINGS

The invention will be described in further detail below and with reference to the attached drawings in which the same or similar elements are referred to by the same number, and where:

FIG. 1 is a schematic diagram of steps for conventional manufacture of catalyst product which is hygroscopic;

FIG. 2 shows examples of catalyst particle shapes;

FIG. 3 is a schematic diagram of steps for manufacture of nonabsorptive catalyst product;

FIG. 4 is a schematic diagram of steps for manufacture of nonabsorptive presulfided catalyst product;

FIG. 5 shows melting and boiling points of n-paraffinic wax used in embodiments herein for manufacture of nonabsorptive catalyst product;

FIG. 6 shows the composition of the n-paraffinic wax used to coat the catalyst particles an example;

FIG. 7 shows environmental scanning electron microscopy (ESEM) topographical image together with the energy-dispersive (EDS) spectrum of a paraffin coated catalyst sample; and

FIG. 8 shows the results of Thermogravimetric Analysis of a paraffin coated catalyst sample.

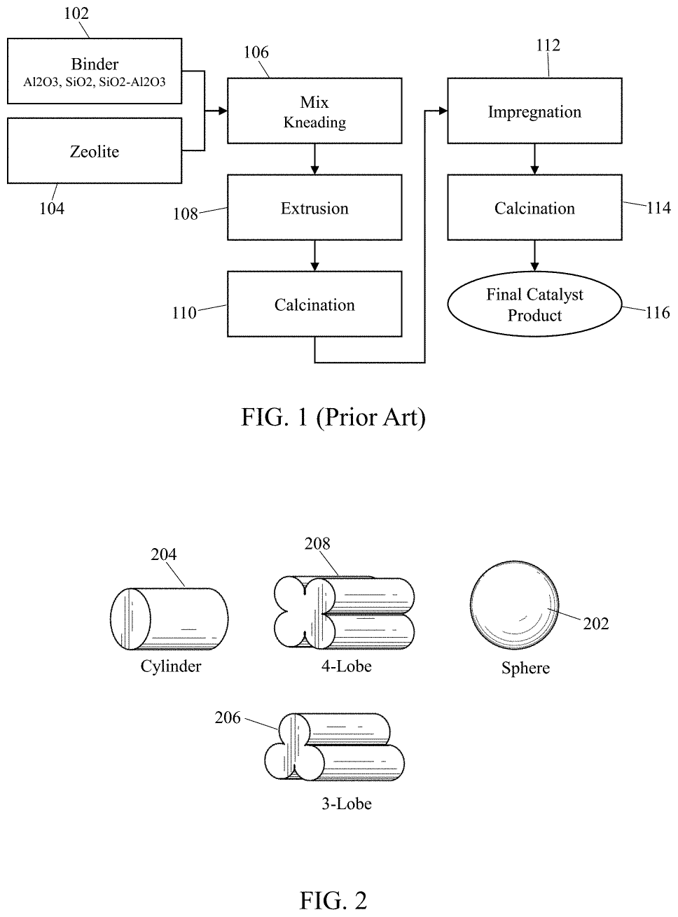

### DETAILED DESCRIPTION

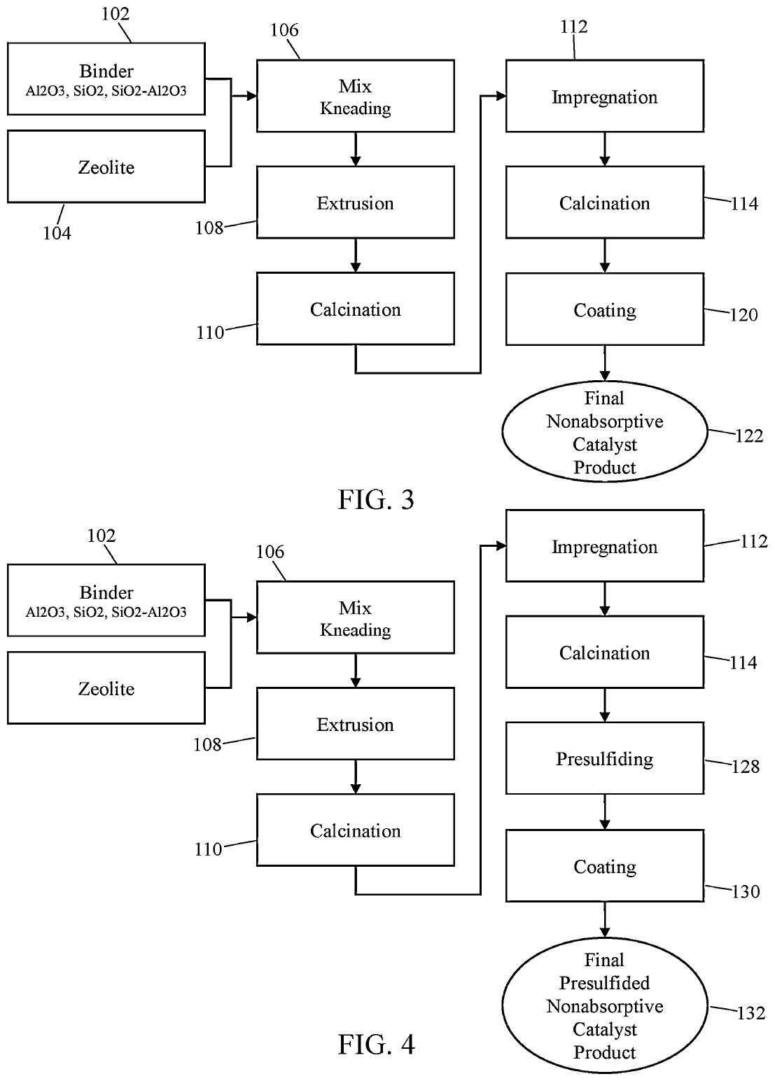

In the present process, catalyst particles are coated with a suitable coating material such as paraffinic oil/wax, or a suitable polymer material, to prevent water adsorption on the catalyst particles. FIG. 3 is a schematic diagram of an embodiment of steps to manufacture nonabsorptive catalyst product by including a coating step. FIG. 4 is a schematic diagram of an embodiment of steps to manufacture nonabsorptive presulfided catalyst product.

FIG. 3 is a schematic diagram of a process for manufacturing nonabsorptive catalyst particles for use as hydroprocessing catalysts. The steps for forming hygroscopic catalyst particles are similar to those described with respect to FIG. 1 herein, including mixing 106 active catalyst support 104 and binder 102, extruding 108 the blend in an extruder and forming catalyst support particles, for example having an average cross-sectional dimension of between about 0.01-3.0 mm, calcining 110 the catalyst support particles; impregnating 112 the catalyst support particles with active phase metals; and calcining 114 the impregnated catalyst particles to remove volatiles and other contaminants. After calcining, the catalyst particles are free of or substantially free water (for example less than about 0.05 or 0.005 W %). The particles are cooled, for instance to room temperature, and at step 120, the hygroscopic impregnated catalyst particles are coated with coating agent(s), to form the final nonabsorptive catalyst particles 122. The coating material is removed from the catalyst particles during reactor startup, for example before the sulfiding occurs. After the coating material is removed, the catalysts can be sulfided at startup as is known in the art.

FIG. 4 is a schematic diagram of a process for manufacturing presulfided nonabsorptive catalyst particles for use as hydroprocessing catalysts. The steps for forming hygroscopic catalyst particles are similar to those described with respect to FIG. 1 herein, including mixing 106 active catalyst support 104 and binder 102, extruding 108 the blend in an extruder and forming catalyst support particles, for example having an average cross-sectional dimension of between about 0.01-3.0 mm, calcining 110 the catalyst support particles; impregnating 112 the catalyst support particles with active phase metals; and calcining 114 the impregnated catalyst particles to remove volatiles and other contaminants. In addition, at step 128, the calcined impregnated catalyst particles are presulfided. After calcining and presulfiding, the catalyst particles are free of or substantially free water (for example less than about 0.05 or 0.005 W %). The particles are cooled, for instance to room temperature, and at step 130, the hygroscopic presulfided impregnated catalyst particles are coated with coating agent(s), to form the final nonabsorptive presulfided catalyst particles 132. The coating material is removed from the catalyst particles during reactor startup, for example without additional sulfiding or before additional sulfiding occurs. In certain embodiments, after the coating material is removed, the presulfided catalysts can be further sulfided during startup.

Catalyst particles that are suitable for the coating processes disclosed herein are comprise at least one or more binder materials and at least one or more active support materials. Examples of binder materials include alumina, silica, titania, silica-alumina, alumina-titania, alumina-zirconia, alumina-boria, phosphorus-alumina, silica-alumina-boria, phosphorus-alumina-boria, phosphorus-alumina-silica, silica-alumina-titania, and silica-alumina-zirconia. Active support materials include zeolitic materials, including but not limited to zeolites with medium or large pore sizes is provided. Examples include, for instance, mordenite, ZSM-5, ZSM-11, ZSM-12, ZSM-22, ZSM-23, ZSM 35, and zeolites of type beta and Y.

The one or more active metal component(s) that are carried on the support material are metals or metal compounds (oxides or sulfides) selected from the Periodic Table of the Elements IUPAC Groups 6, 7, 8, 9 and 10. In certain embodiments, the active metal component(s) is/are one or more of Mo, W, Co or Ni. The active metal component(s) is/are typically deposited or otherwise incorporated on a support, such as amorphous alumina, amorphous silica alumina, zeolites, or combinations thereof. The active metal component(s) are incorporated in an effective concentration, for instance, in the range of (W % based on the mass of the oxides, sulfides or metals relative to the total mass of the catalysts) 1-40, 1-30, 1-10, 1-5, 2-40, 2-30, 2-10, 3-40, 3-30 or 3-10. In certain embodiments, alone or in combination with the above metals, Pt group metals such as Pt and/or Pd, may be present as a hydrogenation component, generally in an amount of about 0.1-2 W % based on the weight of the catalyst.

In certain embodiments, the catalyst particles have a pore volume in the range of about (cc/gm) 0.15-1.70, 0.15-1.50, 0.30-1.50 or 0.30-1.70; a specific surface area in the range of about (m²/g) 100-900, 100-500, 100-450, 180-900, 180-500, 180-450, 200-900, 200-500 or 200-450; and an average pore diameter of at least about 45, 50, 100, 200, 500 or 1000 angstrom units.

The selection of the coating material is such that the material can be formed into a liquid for the coating process as described herein, and can be stripped during a startup period when the coated catalyst is loaded in a reactor. In the coating process, the coating material is heated in a vessel and liquefied at a suitable temperature and pressure. The temperature and pressure conditions for the coating process are selected so that the coating material is in liquid phase to maximize contact with surfaces of the catalyst particles. These coating conditions are below the boiling point of the selected coating material so as to avoid vaporization thereof during the coating process.

During the coating process, the coating material can be provided as a pure material or in a solution. In certain embodiments, the coating material is dissolved in suitable solvent effective for containing the coating material in solution, and also capable of being removed during the coating process. A coating material solution in a solvent con contain any suitable quantity of coating material, for instance 0.1-100, 0.1-99, 0.1-90, 0.1-80, 0.1-70, 0.1-60, 0.1-50, 0.1-25, 0.1-10, 0.1-5, 1-100, 1-99, 1-90, 1-80, 1-70, 1-60, 1-50, 1-25, 1-10, 1-5, 5-100, 5-99, 5-90, 5-80, 5-70, 5-60, 5-50, 5-25 or 5-10 W % of the coating material.

In certain embodiments, the coating material (that is, the material that remains on the catalyst particles after coating) is a heavy paraffin or a mixture containing one or more heavy paraffins having carbon numbers in the range 31-50 (“C31-C50 paraffins”). In further embodiments, the coating material includes a mixture containing one or more heavy C31-C50 paraffins , and one or more paraffinic waxes having lower carbon numbers such as in the range of 15-30, 16-30, 17-30, 18-30 or 19-30. In embodiments using heavy paraffin coating materials, a lighter paraffinic or aromatic solvent (preferably contaminant free) can be used. For example such solvents have a carbon number in the range of 5-7, for instance including one or more of pentane, hexane, benzene, toluene, or a mixture thereof. In certain embodiments a naphtha or light naphtha fraction (preferably hydrotreated), for example boiling in the range of about 36-100° C., can be used.

In further embodiments, the coating material is a polymer or mixtures of polymers, for example originating from olefins, carbonates, aromatics, sulfones, fluorinated hydrocarbons, chlorinated hydrocarbons, and/or acrylnitrodes. In embodiments using polymer coating materials, suitable solvent include acetone, or methanol for acrylnitrodes.

In embodiments in which coating material is used without a solvent, the temperature and pressure conditions for the coating process are related to the melting point and boiling point of the coating material or coating material composition. The pressure is typically in the range of atmospheric pressure (for instance about 1 bar) to about 3 bars. The temperature is at or above the melting point and below the boiling point of a singular coating material. In a mixture of coating materials these are based on the composition of the mixture, for instance using the highest melting point and the lowest boiling point of the range of components. Table 1 shows properties for certain n-alkanes. Table 2 shows properties for certain polymers. In embodiments in which the coating occurs in the absence of a solvent, coating is operated at a temperature of above the melting point of the highest melting material that is intended to remain as part of the coating material on the finished coated catalyst to be shipped. In addition, the maximum temperature during the coating process should not exceed the boiling point of the lowest boiling component of the coating mixture that is intended to remain as part of the coating material on the finished coated catalyst to be shipped (as opposes to a solvent, carrier or other components that are not intended to be retained as part of the coating material on the finished coated catalyst. For example, in embodiments in which the range of intended components on the finished coated catalyst range from C19 to C50, the minimum coating temperature is at least about 92° C., and the maximum coating temperature is no greater than about 331° C. In embodiments in which intended components of the finished coated catalyst are dissolved in a solvent during the coating process, the coating material solution is initially in liquid phase, and lower temperatures can be used for coating; the coating process temperature and pressure conditions are selected so that the coating material remains in liquid phase, whereby the coating material does not precipitate as a solid nor does it vaporize as a gas.

The amount of coating material provided is sufficient to encapsulate the external surfaces of the catalyst particles. For example, the coating thickness of the encapsulation can be in the range of about 0.02-0.2, 0.02-0.15, 0.02-0.1 0.05-0.2, 0.05-0.15 or 0.05-0.1 mm. The catalyst particle should be free or substantially free of the any dust or powder prior to coating, and if any such contaminants are present they should be removed prior to the coating herein.

In the coating process, the coating material is heated in a coating material vessel and maintained in a liquefied state, under temperature conditions generally described above. In coating processes without solvent, conditions include pressures in the range of about 1-3 bars, and temperatures in the range of about 30-331, 30-300, 30-250, 30-200, 50-331, 50-300, 50-250, 50-200, 70-331, 70-300, 70-250 or 70-200° C. In coating processes without solvent, conditions include pressures in the range of about 1-3 bars, and temperatures in the range of about 15-80, 15-50, 15-30, 20-80, 20-50, 20-30, 25-80, 25-50, or 25-30° C. The temperature and pressure of the coating material vessel should be well below the vaporization or decomposition temperature and pressure of the coating material. In certain embodiments, the liquified coating material or coating material solution is sprayed on the catalyst particles, for instance via one or more suitable nozzles. In certain embodiments, for instance in a batch process, trays of catalyst particles can be sprayed with the liquified coating material or coating material solution. In further embodiments, for instance in a continuous process, catalyst particles can traverse so that they can be sprayed with the liquified coating material or coating material, for instance using a conveyor belt. Excess coating material can be collected and recycled back to the coating material vessel for reuse. In other embodiments, liquified coating material or coating material solution is poured over catalyst particles. In another embodiment, the catalyst particles are immersed in the liquified coating material or coating material solution, followed by draining.

The temperature of the coating material should be such that the coating material dries as soon as the particles are separated from the liquid. The residence time of the particles in the liquid coating material should be sufficient for the coating material to encapsulate the catalyst particles, and should be in the range 1-60 or 1-30 seconds. Multiple layers should be avoided to minimize the use of coating material and weight of the catalyst.

In certain embodiments, stripping during startup comprises melting the coating material from the catalyst particles, and accordingly the selection of the coating material or coating material mixture includes those having a melting point in the range of the reactor startup temperature. For instance, the coated catalyst is loaded in a reactor, and the temperature is increased (for example, from ambient temperature) up to the eventual reactor operating temperature. For instance, when C50 paraffins are used as all or part of the coating material or coating material mixture, with a melting point of 92.2° C., startup conditions over that temperature are used, for instance in the range of about 150-500, 200-500, 150-450, 200-450, 150-400, 200-400, 150-360, 200-360, 150-340 or 200-340° C. are suitable.

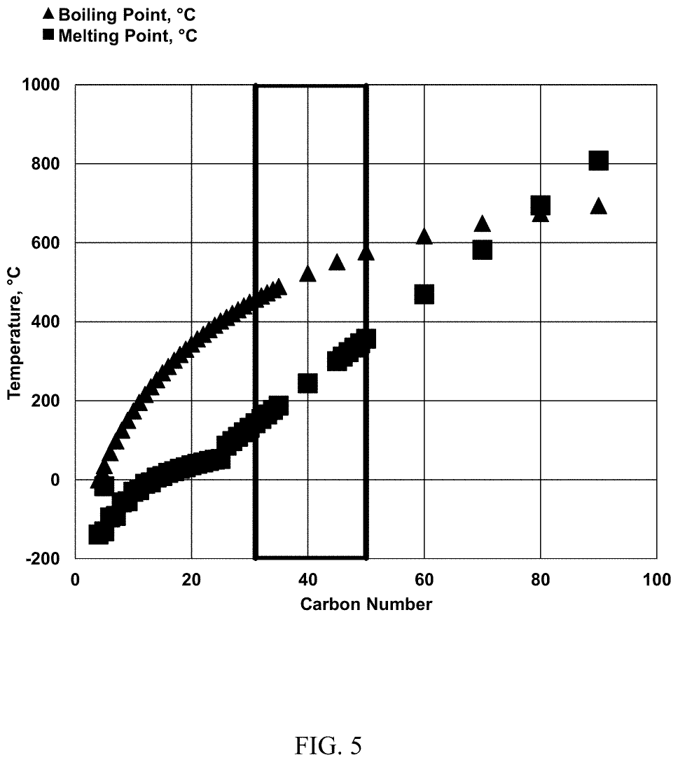

FIG. 5 shows melting and boiling points of n-paraffinic wax used in embodiments herein for manufacture of nonabsorptive catalyst product. A suitable range of n-paraffins wax (carbon numbers 31-50) is shown in a rectangular box; these have high melting points, ranging from about 67.9-92° C., which is an effective range for use as coating material for the catalyst particles as described herein, as said coating materials remain intact, and readily melt within the ranges that are used during reactor startup so that the wax can be removed.

### EXAMPLE

A hydrocracking catalyst was provided including nickel and molybdenum as active phase metals contained in/on a support of an alumina binder and 30 W % Ti—Zr-modified USY zeolite. The Ti—Zr-modified USY zeolite was manufactured as disclosed in U.S. Pat. Nos. 9,221,036, 10,081,009 and 10,293,332, incorporated by reference herein. The hydrocracking catalyst was dried in an oven for 1 hour at 150° C. to remove any volatile materials. A quantity of 5.6 grams of the dried catalyst was added to a wax solution in pentane containing 24 W % of wax. The mixture was stirred until all the solvent evaporated. The final weight of the catalyst was 6.8 grams, indicating that 1.2 grams of wax was coated on catalyst particles.

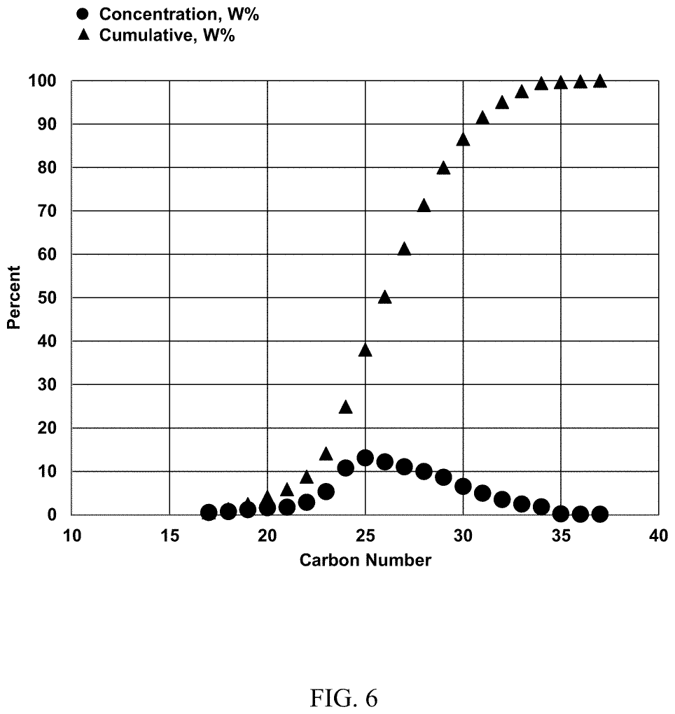

FIG. 6 shows the composition of the coating material used to coat the catalyst particles. The circular marks in FIG. 6 represent the concentration (W %) of the n-alkane in the coating material of the noted carbon number. For example, the wax used contained 13.1 W % of N-pentacosane, a paraffin with carbon number of 25, and 6.6 W % of N-triacontane, a paraffin with carbon number of 30. The triangular marks represent the cumulative concentration of the n-alkanes in the coating material. At room temperature (20° C.) all n-alkanes in the mixture are solid.

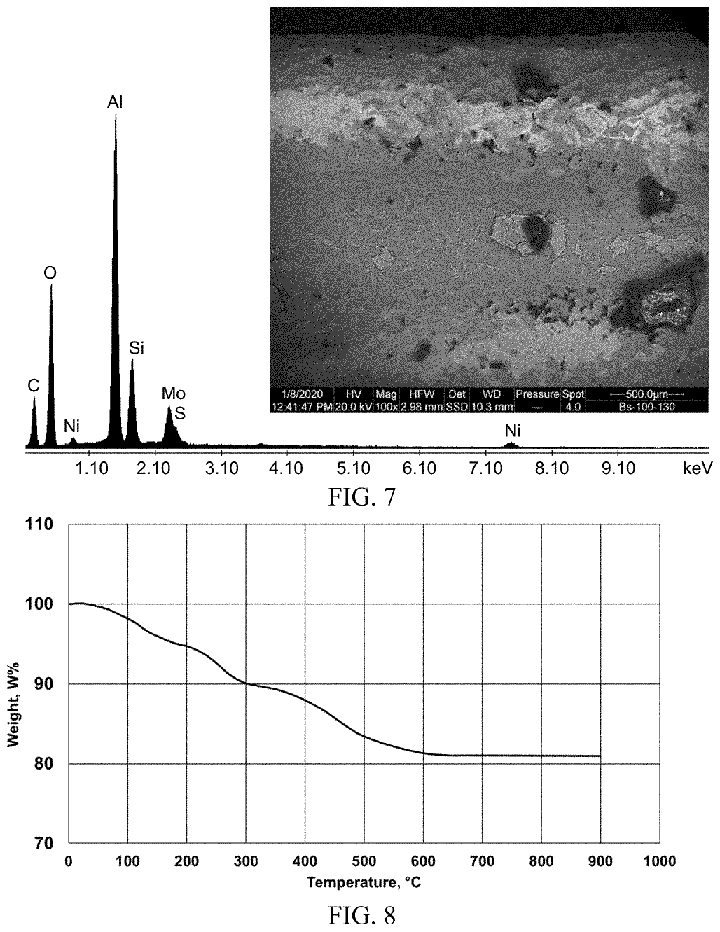

FIG. 7 shows the environmental scanning electron microscopy (ESEM) topographical image together with the energy-dispersive (EDS) spectrum of the paraffin coated catalyst sample. As seen, the catalyst surface is fully covered with the paraffin wax. FIG. 8 shows the results of Thermogravimetric Analysis of the paraffin coated catalyst sample. The samples were analyzed using TGA Q500 (Thermal Analyzer) instrument. In the TGA method, the sample is weighed and placed in the TGA sample device. The analysis was carried out from 25° C. to 900° C. at a heating rate of 20° C./min under air atmosphere in order to determine the weight losses and residual mass of the sample. As seen, approximately 19 W % of the material is lost during the heating, corresponding to the approximate percent of wax on the coated particles (1.2 g wax/6.8 g total weight of coated catalyst particles). The remaining material is the mass of the catalyst particles.

The methods and systems of the present invention have been described above and in the attached drawings; however, modifications will be apparent to those of ordinary skill in the art and the scope of protection for the invention is to be defined by the claims that follow.

TABLE 1

| n-alkane | IUPAC | Melting | Boiling |
|---|---|---|---|
| Carbon Number | Name | Point (° C.) | Point (° C.) |
| 4 | n-butane | −138.2 | −0.5 |
| 5 | neopentane | −16.4 | 9.5 |
| 5 | n-pentane | −129.7 | 36.0 |
| 6 | n-hexane | −95.3 | 68.7 |
| 7 | n-heptane | −90.6 | 98.5 |
| 8 | n-octane | −56.8 | 125.6 |
| 9 | n-nonane | −53.5 | 150.8 |
| 10 | n-decane | −29.7 | 174.1 |
| 11 | n-undecane | −25.6 | 195.9 |
| 12 | n-dodecane | −9.6 | 216.3 |
| 13 | n-tridecane | −5.3 | 235.4 |
| 14 | n-tetradecane | 5.8 | 253.5 |
| 15 | n-pentadecane | 9.9 | 270.6 |
| 16 | n-hexadecane | 18.1 | 286.8 |
| 17 | n-heptadecane | 22.0 | 302.0 |
| 18 | n-octadecane | 28.2 | 316.3 |
| 19 | n-nonadecane | 32.1 | 329.9 |
| 20 | n-eicosane | 36.8 | 343.0 |
| 21 | n-heneicosane | 40.5 | 356.5 |
| 22 | n-docosane | 44.4 | 368.6 |
| 23 | n-tricosane | 47.6 | 380.0 |
| 24 | n-tetracosane | 54.0 | 391.3 |
| 25 | n-pentacosane | 54.0 | 401.9 |
| 26 | n-hexacosane | 56.4 | 412.2 |
| 27 | n-heptacosane | 59.5 | 442.0 |
| 28 | n-octacosane | 64.5 | 431.6 |
| 29 | n-nonacosane | 63.7 | 440.8 |
| 30 | n-triacontane | 65.8 | 449.7 |
| 31 | n-hentriacontane | 67.9 | 458.0 |
| 32 | n-dotriacontane | 69.7 | 467.0 |
| 33 | n-tritriacontane | 72.0 | 476.0 |
| 34 | n-tetratriacontane | 72.6 | 483.0 |
| 35 | n-pentatriacontane | 75.0 | 490.0 |
| 40 | n-tetracontane | 82.0 | 522.0 |
| 50 | n-pentacontane | 92.0 | 575.0 |
| 60 | n-hexacontane | 100.0 | 625.0 |

Data is from the National Library of Medicine, PubChem (site: https://pubchem.ncbi.nlm.nih.gov), using the values from the source EPA DSSTox. Exceptions are n-tetracontane where the boiling point is obtained from Peter Morgan, Analysis of Petroleum Fractions by ASTM D2887, Thermo Fisher Scientific Inc. (2012) (publication AN20582_E 08/12S) https://static.thermoscientific.com/images/D22163˜.pdf, and where the data for melting and boiling point data for n-pentacontane and n-hexacontane is from https://www.engineeringtoolbox.com/hydrocarbon-boiling-melting-flash-autoignition-point-density-gravity-molweight-d_1966.html.

TABLE 2

| Polymer | Example | Melting | |
|---|---|---|---|
| family | polymer | Point, ° C. | Structure |
| Olefins | Polyethylene | 115-135 | 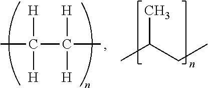 |
| Olefins | polypropylene | 115-135 | 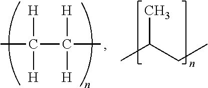 |
| carbonates | diphenyl- carbonate | 83 | 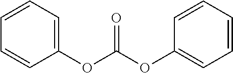 [SMILES: O=C(Oc1ccccc1)Oc1ccccc1] |
| aromatics | Polystyrene | 240 | 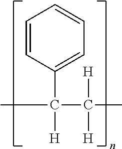 |
| Sulfones | Polyether sulfone | 227-238 | 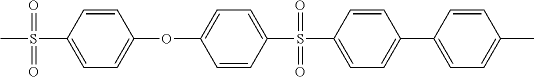 |
| Fluorinated hydrocarbons | Polytetra- fluoroethylene | 327 | 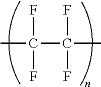 |
| Chlorinated hydrocarbons | Polyvinyl chloride | 100-260 | 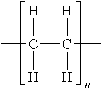 |
| Acyrilnitriles | Polyacrylonitrile | 300 | 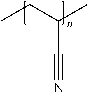 |

1. The method of claim 16, wherein the nonabsorptive catalyst particles are formed by the process of:
mixing zeolite and metal oxide binder material to form a catalyst support blend;
extruding and forming the catalyst support blend in an extruder to produce catalyst support particles having an average cross-sectional dimension of between about 0.01-3.0 mm;
calcining the catalyst support particles to produce calcined catalyst support particles;
incorporating the one or more active metal components in the calcined catalyst support particles to produce catalyst particles having active metal components;
calcining the catalyst particles having active metal components to remove water, volatile and contaminant materials and oxidize the active metal component to produce hygroscopic catalyst particles having oxidized active metal components thereon having less than about 0.05 w % water; and
coating the hygroscopic catalyst particles with the coating material to produce the nonabsorptive catalyst particles.

2. The method of claim 21, wherein the nonabsorptive presulfided catalyst particles are formed by the process of:
mixing zeolite and metal oxide binder material to form a catalyst support blend;
extruding and forming the catalyst support blend in an extruder to produce catalyst support particles having an average cross-sectional dimension of between about 0.01-3.0 mm;
calcining the catalyst support particles to produce calcined catalyst support particles;
incorporating the one or more active metal components in the calcined catalyst support particles to produce catalyst particles having active metal components;
calcining the catalyst particles having active components to remove volatile and contaminant materials to produce hygroscopic catalyst particles;
presulfiding the hygroscopic catalyst particles to sulfide active metal components from oxidized form to sulfided form thereby producing presulfided hygroscopic catalyst particles having less than about 0.05 w % water; and
coating the presulfided hygroscopic catalyst particles with the coating material to produce the nonabsorptive presulfided catalyst particles.

3. (canceled)

4. (canceled)

5. (canceled)

6. The method of claim 16, wherein the coating material is an n-paraffin wax.

7. The method of claim 1, wherein coating material is dissolved in a paraffinic solvent with a carbon number in the range of 5-7.

8. The method of claim 7, wherein the solvent is pentane, hexane, or naphtha boiling in the range of 36-100° C.

9. (canceled)

10. The method of claim 1, wherein the coating material is spayed over the hygroscopic catalyst particles in a batch or continuous manner.

11. The method of claim 1, wherein the coating material is poured over the hygroscopic catalyst particles.

12. The method of claim 1, wherein the hygroscopic catalyst particles are immersed in coating material and drained.

13. The method of claim 1, wherein coating occurs at a temperature that is greater than the melting point of the coating material and less than the boiling point of the coating material.

14. The method of claim 1, wherein coating occurs at a pressure range of about 1-3 bars

15. The method of claim 1, wherein the catalyst is cooled to room temperature before it is coated.

16. A hydroprocessing method for hydrodesulfurization, hydrodenitrogenation, hydrocracking, hydrodewaxing, hydrogenation, and/or hydrodemetalization of petroleum and petroleum fractions, the method comprising:
loading into a reactor nonadsorptive catalyst particles comprising zeolite and metal oxide binder material extrudates incorporating oxidized active metal components selected from the group consisting of Mo, W and Ni, and having less than about 0.05 w % water, the extrudates encapsulated with a coating material comprising a mixture containing one or more heavy C31-C50 paraffins, and one or more C15-C30 paraffins;
heating reactor during startup to a temperature in the range of about 150-500° C. to remove coating material from the catalyst particles.

17. The method as in claim 16, further comprising sulfiding the catalyst particles after coating material is removed.

18. (canceled)

19. The method of claim 16, wherein the coating material comprises n-paraffinic wax with carbon number in the range of 31-50.

20. (canceled)

21. A hydroprocessing method for hydrodesulfurization, hydrodenitrogenation, hydrocracking, hydrodewaxing, hydrogenation, and/or hydrodemetalization of petroleum and petroleum fractions, the method comprising:
loading into a reactor nonadsorptive presulfied catalyst particles comprising zeolite and metal oxide binder material extrudates incorporating oxidized active metal components selected from the group consisting of Mo, W and Ni, and having less than about 0.05 w % water, the extrudates encapsulated with a coating material comprising a mixture containing one or more heavy C31-C50 paraffins, and one or more C15-C30 paraffins;
heating reactor during startup to a temperature in the range of about 150-500° C. to remove coating material from the presulfied catalyst particles.
